(19) United States
(12) Patent Application Publication
(10) Pub. No.: US 2006/0204156 A1
(43) Pub. Date: Sep. 14, 2006

(54) Wheel supporting bearing assembly and method for producing the same

(75) Inventors: Tetsu Takehara, Kanagawa (JP); Natsuki Sensui, Kanagawa (JP); Hironari Sakoda, Kanagawa (JP); Nobuyuki Hagiwara, Kanagawa (JP); Taketoshi Chifu, Kanagawa (JP); Shingo Nagoshi, Kanagawa (JP); Toshihide Tsuzuki, Saitama (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 11/370,035

(22) Filed: Mar. 8, 2006

(30) Foreign Application Priority Data
Mar. 8, 2005 (JP) P. 2005-064385

(51) Int. Cl. F16C 41/04; F16C 13/00; F16C 32/00

(52) U.S. Cl. 384/544; 384/448

(57) ABSTRACT

A construction is adopted in which an annular spacer 27 is held between first and second inner races 2a, 2b. An internal clearance in a double-row bearing unit is measured in a middle step of assembling work of a wheel supporting bearing assembly, and in the event that a resultant measured value does not become a proper value, an axial dimension of the spacer 27 is adjusted, so that the internal clearance becomes the proper value. Thereafter, the assembling work is made to continue until the assembling work is completed. A problem which is to be solved by the invention is solved in the way described above.

### BACKGROUND OF THE INVENTION

1. Technical Field

The present invention relates to a wheel supporting bearing assembly which is used to support a wheel on a suspension system in a rolling fashion and a method for producing the same.

2. Related Arts

Conventionally, wheel supporting bearing assemblies have been used to support rotatably wheels on suspension systems of motor vehicles. FIG. 20 shows a wheel supporting bearing assembly for a driving wheel (one of front wheels of an FF (front engine, front wheel drive) vehicle, one of rear wheels of FR (front engine, rear wheel drive) and RR (rear engine, rear wheel drive) vehicles, one of four wheels of a four-wheel drive vehicle) as a first example of the construction of the conventional wheel supporting bearing assemblies. This wheel supporting bearing assembly includes an outer race 1, first and second inner races 2a, 2b, a plurality of tapered rollers 3, 3 which are each rolling elements and a hub 4, which is a shaft member.

Of the constituent parts, the outer race 1 has first and second outer race raceways 5a, 5b, each having a coned surface, which are formed on an inner circumferential surface thereof and a connecting flange 6 which is formed on an outer circumferential surface thereof. The first and second outer race raceways 5a, 5b are inclined in opposite directions to each other. In addition, the first inner race 2a has a first inner race raceway 7a, having a coned surface, which is formed on an outer circumferential surface thereof, and the second inner race 2b has a second inner race raceways 7b, having a coned surface, which is formed on an outer circumferential surface thereof. The first and second inner races 2a, 2b, which are configured as has been described above, are disposed radially inwards of the outer race 1 concentrically with the outer race 1 in such a state that respective small-diameter side end faces thereof are in abutment with each other. In addition, the pluralities of tapered rollers 3, 3 are provided rollingly between the first and second outer race raceways 5a, 5b and the first and second inner race raceways 7a, 7b, respectively, in such a state that the tapered rollers are retained in cages 8, 8.

Additionally, the hub 4 has a mounting flange 9 on which a wheel is fixedly supported, a cylindrical surface portion 10 and a splined bore 11, the mounting flange 9 being formed on an outer circumferential surface of the hub 4 at a portion close to an outboard end thereof (here, axially outside or outboard means transversely outside or outboard of a vehicle in such a state that the wheel supporting bearing assembly is assembled to the vehicle, and in all the accompanying drawings except for FIG. 9, the axially outside or outboard lies to the left side in the drawings. On the contrary, the right side in all the drawings except for FIG. 9 which denotes a portion lying to a transversely central portion of the vehicle is referred to as axially inside or inboard.), the cylindrical surface portion 10 being formed on the outer circumferential surface at a portion lying from a central to inboard end portion thereof, the splined bore 11 being formed in a radially central portion of the hub. Of these hub constituent parts, the first and second inner races 2a, 2b are fitted to be supported on the cylindrical surface portion 10 with interferences (or are press fitted), respectively. In addition, in this state, a large-diameter side end face of the first inner race 2a is brought into colliding abutment with a stepped surface 12 provided at a proximal end portion of the cylindrical surface portion 10, while a large-diameter side end face of the second inner race 2b is made to project further axially inboard than an inboard end face of the hub 4.

When the wheel supporting bearing assembly which is configured as has been described above is assembled to a motor vehicle, a splined shaft 14, which is a drive shaft fixedly provided at a central portion on an outboard end face of a constant velocity joint outer race 13 is, as shown in the figure, inserted into the splined bore 11, and an outside-diameter side portion on the outboard end face of the constant velocity joint outer race 13 is brought into colliding abutment with the large-diameter side end face of the second inner race 2b. Then, in this state, a nut 16 is screwed onto an externally threaded portion 15 provided on a portion of an distal end portion of the splined shaft 14 which protrudes from the splined bore 11 and is tightened further, whereby the spline shaft 14 and the hub 4 are fixedly connected to each other, and the tightening force of the nut 16 functions to apply a force to the first and second inner races 2a, 2b which are held between the stepped surface 12 provided on the outer circumferential surface of the hub 4 and the outboard end face of the constant velocity joint outer race 13 in a direction which causes the first and second inner races 2a, 2b to approach each other. In addition, the connecting flange 6 is fixedly connected to a knuckle 17 which makes up a suspension system using a bolt 18, and a wheel and a brake rotor, which are both not shown, are fixedly supported on the mounting flange 9.

Note that while, in this example, the connecting flange 6 is provided on the outer circumferential surface of the outer race 1, conventionally there has existed a construction in which the outer circumferential surface of the outer race 1 is formed into a simple cylindrical surface. In the case of such a construction, an outer race whose outer circumferential surface is formed into a simple cylindrical surface is fitted to be supported inside a circular supporting bore provided in a knuckle which makes up the suspension system while being positioned properly in the axial direction. In addition, while, in the example shown in the figure, the first inner race 2a is fixedly fitted on the cylindrical surface 10 of the hub 4, conventionally there has existed a construction in which the first inner race 2a is formed integrally with the hub 4.

Next, FIG. 21 shows a second example of the construction of the conventional wheel supporting bearing assemblies. In the case of a wheel supporting bearing assembly of the second example, a cylindrical portion 19 is provided on a portion of an inboard end portion of a hub 4a which protrudes further axially inwards than an outside-diameter side end face of a second inner race 2b, and the cylindrical portion 19 is plastically deformed radially outwards, whereby a clamping portion 20 is formed. Then, the outside-diameter side end face of the second inner race 2b is pressed against a stepped surface 12 provided on an outer circumferential surface of the hub 4a at an intermediate portion thereof by the clamping portion 20 so as to be secured in place. In addition, by press securing the second inner race 2b like this, a force is applied to the first and second inner races 2a, 2b in a direction which causes the first and second inner races 2a, 2b to approach each other with respect to an axial direction thereof. The configuration and function of the other portions of the wheel supporting bearing assembly of the second example are similar to those of the first example of the conventional construction.

Next, FIG. 22 shows a wheel support bearing system for a driven wheel (one of rear wheels of the FF vehicle, one of front wheels of the FR and RR vehicles) as a third example of the construction of the conventional wheel supporting bearing assemblies. Since this wheel supporting bearing assembly of the third example is for the driven wheel, a splined bore is not provided in a radially central portion of a hub 4b. Instead, an externally threaded portion 21 is provided at an inboard end portion of the hub 4b. In addition, a large-diameter side end face of a second inner race 2b is pressed against a stepped surface 12 formed on an outer circumferential surface of the hub 4b at an intermediate portion thereof by a nut 22 which is screwed and tightened further onto the externally threaded portion 21. Thus, by press securing the second inner race 2b like this, a force is applied to the first and second inner races 2a, 2b in a direction which causes the first and second inner races 2a, 2b to approach each other with respect to an axial direction thereof. The configuration and function of the other portions of the wheel supporting bearing assembly of the second example are similar to those of the first example of the conventional construction. Note that although not shown, in the event of the wheel supporting bearing assembly for the driven wheel, as with the second example that has been described before, there occurs a case where a construction is adopted in which a clamping portion is formed at the inboard end portion of the hub so as to press secure the large-diameter side end face of the second inner race by the clamping portion so formed.

Next, FIG. 23 shows, as a fourth example of the construction of the conventional wheel supporting bearing assemblies, a wheel supporting bearing assembly with a wheel rotational speed detecting device or sensor which is described in Patent Document No. 1. In the case of this fourth example, an axial dimension of a small-diameter side end portion of a first inner race 2c is made larger than an axial dimension of a small-diameter side end portion of a second inner race 2b. In addition, an encoder 23, which is a rotor, is fixedly fitted on the small-diameter side end portion of the first inner race 2c by means of interference fit. This encoder 23 is such as to be called a so-called pulser gear which is made by forming a magnetic metal material such as soft steel into an annular shape and forming gear-tooth like indentations on an outer circumferential surface thereof, and the magnetic characteristics of the outer circumferential surface are made to change alternately and at equal intervals. On the other hand, a mounting hole 24 is formed in an outer race 1 at an axially intermediate portion thereof in such a manner as to establish a communication between internal and external circumferential surfaces of the outer race 1, and a wheel rotational speed detecting sensor 25 is inserted and supported in the mounting hole 24. In addition, in this state, a detecting portion provided at a distal end face (an upper end face in FIG. 23) of the wheel rotational speed detecting sensor 25 is made to face an outer circumferential surface of the encoder 23 in close proximity.

With the wheel supporting bearing assembly with a wheel rotational speed detecting device that has been configured as has been described above assembled between a suspension system and a wheel for use, when the wheel rotates, the recessed portions and raised portions existing on the outer circumferential surface of the encoder 23 pass alternately in the vicinity of a detecting surface of the wheel rotational speed detecting sensor 25. As a result, the density of magnetic flux which flows within the wheel rotational speed detecting sensor 25 changes, and the output of the wheel rotational speed detecting sensor 25 changes. Since a frequency at which the output changes is in proportion to the rotational speed of the wheel, when output signals are sent to a control unit, not shown, an ABS and a TCS can be controlled properly. In addition, a rotational angle and a rotational speed can also be detected. The construction and function of the other portions of the fourth example are similar to those of the conventional constructions that have been described above. Note that in the example shown in FIG. 23, the axial positioning of the encoder 23 is realized based on only a frictional force exerted on the fitting portion between the first inner race 2c and the encoder 23.

In addition, in the individual conventional constructions, since the automotive wheel supporting bearing assemblies are heavy, the tapered rollers 3, 3 are used as the rolling elements, however, for an automotive wheel supporting bearing assembly which is not heavy, balls are used as rolling elements.

Incidentally, each of the wheel supporting bearing assemblies that have been described above is used in such a state that a pre-loaded load is applied to a double-row bearing unit which is made up by assembling together the outer race 1, the first and second inner races 2a (2c) 2b, the rolling elements (tapered rollers 3, 3 or balls) and the cages 8, 8. This pre-loaded load (the internal clearance) is set to such an appropriate value that required bearing performances (life, anti-seizing property, rigidity and the like) are satisfied.

The internal clearance in the double-row bearing unit when the wheel supporting bearing assembly is in use is determined mainly by the following three parameters (A) to (C).

(A) An internal clearance in the double-row bearing unit which results after the double-row bearing unit is made by bringing the axial end faces of the individual members into abutment with each other and before the first and second inner races 2a (2c), 2b are fitted on the cylindrical surface portion 10 of the hub 4 (4a, 4b) with interferences;

(B) A reduction amount in the internal clearance in the double-row bearing unit which is produced in association with the fitting of the first and second inner races 2a (2c), 2b on the cylindrical surface portion 10 with interferences (a resultant expansion of the individual inner races 2a (2c), 2b); and

(C) A reduction amount in the internal clearance in the double-row bearing unit which is produced in association with the application of a strong force to the first and second inner races 2a (2c), 2b in the direction which causes the first and second inner races 2a (2c), 2b to approach each other with respect to the axial direction thereof by the tightening force of the nut 16 (22) or press securing force of the clamping portion 20 (as a result, the inner races 2a (2c), 2b contract in the axial direction while the outside diameters thereof expand).

Namely, the internal clearance in the double-row bearing unit when the wheel supporting bearing assembly is in use is can be expressed as (A)−{(B)+(C)} by using the above three parameters (A) to (C). Then, conventionally, in order to set the internal clearance in the double-row bearing unit in use to a proper value, a proper value for the internal clearance in (A) is determined in consideration of the reduction amounts in (B) and (C). In addition, dimensions of the individual constituent parts of the double-row bearing unit are determined so as to realize the proper value for the internal clearance in (A).

In reality, however, since the respective values of (A) to (C) vary due to production errors of the relevant constituent parts, the internal clearance in use varies from the proper value which functions as a center of variability. Since the variability of the internal clearance in use like this affects the stabilization of the bearing performance, the variability of the internal clearance should desirably be reduced. In order to reduce the variability of the internal clearance in use, the variability of each of the values of (A) to (C) may only have to be reduced. In this case, in particular, the reduction in variability of the value of (A) constitutes a base in reducing the variability of the internal clearance, and therefore, it is of most importance.

In order to reduce the variability of each of the values of (A) to (C), the production errors of the individual constituent parts of the wheel supporting bearing assembly may only have to be reduced, and to be specific, the machining accuracy of each of the parts may only have to be increased. When considering costs, however, there exists a certain limitation on the enhancement of machining accuracy. Consequently, in order to reduce further the variability of the internal clearance in use, another solution is requested to be realized which can replace or be used in parallel with the approach of enhancing the machining accuracy. To deal with this issue, an approach is described in Patent Document No. 2 which can meet the request. In the case of the approach described in Patent Document No. 2, firstly, a proper value for the internal clearance of (A) is determined in the way described above, and thereafter, the internal clearance of (A) is measured for each wheel supporting bearing assembly that is actually assembled. Then, in the event that the measured value does not fall within the proper value, the small-diameter side end face of at least one of the first and second inner races 2a (2c), 2b is ground so that the internal clearance of (A) becomes the proper value. Thus, in the event of the approach described in Patent Document No. 2, the internal clearance of (A) can be made to coincide with the proper value. Namely, since the variability of the value of (A) can be suppressed, the variability of the internal clearance in use can be reduced by such an extent.

In the case of the approach described in Patent Document No. 2, however, the following disadvantages are produced. Namely, from the view point of making efficient the assembling work of the wheel supporting bearing assembly, the grinding work of grinding the small-diameter side end face of the inner race in a way as described above is preferably performed with the plurality of rolling elements 3, 3 and the cage 8 assembled to the inner race to be ground (namely, in such a state that the inner race unit is kept completed). When the grinding work is performed in such a state, however, there may be caused a possibility that grinding dust (metallic dust) produced at the time of grinding the inner race intrudes into the inner race unit. Once grinding dust enters the inner race unit, it is hard to remove it, resulting in a possibility that the grinding dust remains in a completed double-row bearing unit. Then, the remaining winding dust damages the surfaces of the raceways and the rolling elements 3, 3 when in operation to thereby reduce the life of the double-row bearing unit, which is undesirable. Consequently, in order to prevent the occurrence the disadvantage, a device needs to be provided on the machining apparatus which prevents the intrusion of grinding dust into the inner race unit. However, this attempt results in a disadvantage where the cost for the machining apparatus is increased. To deal with this, in the event that the work of grinding the small-diameter side end face of the inner race is performed with the individual rolling elements 3, 3 and the cage 8 removed from the inner race, the aforesaid disadvantage can be prevented from occurring, but the efficiency of the assembling work of the wheel supporting bearing assembly is deteriorated.

Incidentally, in the case of the wheel supporting bearing assemblies illustrated in FIGS. 20 to 23 in which the first and second inner races 2a (2c), 2b and the hub 4, 4a, 4b are parts which are independent from each other, in the event that the axial dimensions of both the inner races 2a (2c), 2b can be made substantially equal to each other, the commonization of parts on both the inner races 2a (2c), 2b can be realized or at least, both the inner races 2a (2c), 2b can be produce with good efficiency on the same (or a single) machining line, which is preferable. In the case of the wheel supporting bearing assembly with a wheel rotational speed detecting device illustrated in FIG. 23, however, since the encoder 23 is fitted to be supported on the small-diameter side end portion of the first inner race 2c, the axial dimension of the small-diameter side end portion of the first inner race 2c is made quite larger than the axial dimension of a small-diameter side end portion of the second inner race 2b. Due to this, the axial dimensions of both the inner races 2c, 2b cannot be made substantially equal to each other. Thus, in the event that the axial dimensions of both the inner races 2c, 2b cannot be made substantially equal to each other, since these inner races 2c, 2b are normally produced using different (two) machining lines, an investment cost for facility is increased. In this case, although these inner races 2c, 2b can be produced using the same (a single) machining line, in the event that such is the case, since a change in arrangement becomes necessary so that the inner races 2c, 2b are conveyed alternately on the relevant machining line, and furthermore, time necessary to machine the inner races 2c, 2b individually has to be extended, it becomes hard to produce the inner races 2c, 2b with good efficiency. Consequently, even in the event that a configuration is adopted in which a wheel rotational speed detecting device is assembled between a pair of rows of rolling elements, it is desired to make the axial dimensions of the individual inner races 2c, 2b substantially equal to each other in order to prevent the occurrence of the aforesaid disadvantages.

[Patent Document No. 1]
U.S. Pat. No. 5,085,519 Specification

[Patent Document No. 2]
JP-T-2004-158912 (the term “JP-T” as used herein means a published Japanese translation of a PCT application)

### DISCLOSURE OF THE INVENTION

### Problems to be Solved by the Invention

The invention is made in the light of the situations and an object thereof is to realize a wheel supporting bearing assembly and a method for producing the same which can not only suppress the variability of the internal clearance in the double-row bearing unit when in use but also prevent the intrusion of grinding dust of the parts into the interior of the double-row bearing unit when assembled and, moreover, which can make the axial dimensions of the pair of inner races substantially equal to each other even when the configuration is adopted in which the wheel rotational speed detecting device is assembled between the pair of rows of rolling elements.

### Means for Solving the Problem

Of a wheel supporting bearing assembly and a method for producing the same, a wheel supporting bearing assembly as set forth in a first aspect of the invention includes an outer race, a pair of inner races, pluralities of rolling elements, and a shaft member.

In addition, of these constituent members, the outer race has a plurality of rows of outer race raceways formed on an inner circumferential surface thereof.

Additionally, one of the pair of inner races has a single row of inner race raceway formed on an outer circumferential surface thereof and being fitted on an outer circumferential surface of the shaft member with an interference at a portion thereof or formed integrally with the shaft member at the portion thereof.

Furthermore, the other inner race has a single row of inner race raceway formed on an outer circumferential surface thereof and being fitted on the outer circumferential surface of the shaft member with an interference at another portion on the remaining part thereof which lies side by side to the portion where the one of the pair of inner races is disposed.

In addition, the rolling elements are provided in such a manner that the plurality of rolling elements are interposed rollingly between each of the outer race raceways and each of the inner race raceways.

Then, the wheel supporting bearing assembly is adapted to be used in such a state that a force is applied to the pair of inner races in a direction which causes the inner races to approach each other with respect to an axial direction thereof.

In particular, in the wheel supporting bearing assembly set forth in the first aspect of the invention, an annular spacer is held between respective axial end faces of the pair of inner races which face each other. Note that this spacer is fitted on the outer circumferential surface of the shaft member with a slight clearance or interference.

In addition, according to a wheel supporting bearing assembly as set forth in a third aspect of the invention, a rotor making up a wheel rotational speed detecting device is fitted to be supported on an outer circumferential surface of the spacer.

Additionally, according to a wheel supporting bearing assembly as set forth in a fifth aspect of the invention, a rotor making up a wheel rotational speed detecting device is integrally provided on an outer circumferential surface of the spacer.

In addition, according to a seventh aspect of the invention, there is provided a wheel supporting bearing assembly production method for producing the wheel supporting bearing assembly of the invention, in which an axial dimension of the spacer is determined in a middle step of assembling work of the individual parts which make up the wheel supporting bearing assembly, and a spacer having the axial dimension so determined is used for assembly of the wheel supporting bearing assembly.

Specifically speaking, as is set forth in an eighth aspect of the invention, an internal clearance of a double-row bearing unit made up by assembling together a pair of inner races, an outer race, pluralities of rolling elements and a spacer is measured in the middle step of the assembling work of the individual parts which make up the wheel supporting bearing assembly, and in the event that a resultant measured value does not coincide with a proper value which is determined in advance for the internal clearance of the double-row bearing unit in the middle step, in place of the spacer which is used for the measurement, a spacer having an axial dimension which can align the internal clearance with the proper value or make the internal clearance fall within a desired range (preferably, a range being as narrow as possible) which is centered the proper value is used as a constituent part of the wheel supporting bearing assembly in assembly of the individual parts.

### Advantages of the Invention

According to the wheel supporting bearing assembly and the production method therefor of the invention, since the variability of the internal clearance in the double-row bearing unit in use can be reduced, the stabilization of bearing performances (life, anti-seizing property, rigidity and the like) can be realized. In addition, according to the invention, the method for adjusting the axial dimension of the spacer is adopted as the means for adjusting the internal clearance in the double-row bearing unit in the middle step of the assembling process. Due to this, in performing work in which the internal clearance is adjusted in the middle step, even though there occurs a case where an axial end face of the spacer needs to be ground, the small-diameter side end faces of the pair of inner races do not have to be ground. Consequently, according to the invention, in performing work in which the internal clearance is adjusted in the middle step, the intrusion of grinding dust into the interior of the double-row bearing unit can be prevented.

In addition, in the wheel supporting bearing assembly according to the invention, in a case where a construction is adopted in which the pair of inner races and the shaft member are made up of parts which are separate from each other, even in the event that a wheel rotational speed detecting device is constructed so as to be assembled between the pair of rows of rolling elements, the axial dimensions of the pair of inner races can be made substantially equal to each other. Namely, according to the wheel supporting bearing assembly of the invention, when the wheel rotational speed detecting device is constructed so as to be assembled between the pair of rows of rolling elements, the rotor which makes up the wheel rotational speed detecting device is fitted to be supported on the spacer (the third aspect of the invention) or is provided integrally with the spacer (the fifth aspect of the invention). Due to this, there is no need to provided a fitting portion on which the rotor is fitted to be supported at the small-diameter side end portion of either of the pair of inner races. Consequently, according to the invention, even in the event that the construction is adopted in which the wheel rotational speed detecting device is assembled between the pair of rows of rolling elements, the axial dimensions of the pair of inner races can be made substantially equal to each other. As a result, the commonization of parts on the pair of inner races can be realized, or the pair of inner races can be produced individually with good efficiency using the same (a single) machining line without a change in arrangement of the production lines. Consequently, the production costs for the pair of inner races can be suppressed.

### BRIEF DESCRIPTION OF THE DRAWINGS

FIG. 1 is a sectional view which shows Embodiments 1 to 3 of the invention.

FIG. 2 is a sectional view which shows Embodiment 4 of the invention.

FIG. 3 is a sectional view which shows Embodiment 5 of the invention.

FIG. 4 is a sectional view which shows Embodiment 6 of the invention.

FIG. 5 is a sectional view which shows Embodiment 7 of the invention.

FIG. 6 is a sectional view which shows Embodiment 8 of the invention.

FIG. 7 is a sectional view which shows Embodiment 9 of the invention.

FIG. 8 is an enlarged view of a portion indicated by A in FIG. 7.

FIG. 9 is a sectional view taken along the line B-B in FIG. 8.

FIG. 10 is a sectional view which shows Embodiment 10 of the invention.

FIG. 11 is an enlarged view of a portion indicated by C in FIG. 10.

FIGS. 12A-12B show similar views to FIG. 11 which show two examples of axial positioning constructions of an encoder.

FIG. 13 is a sectional view which shows Embodiment 11 of the invention.

FIG. 14 is a sectional view which shows Embodiment 12 of the invention.

FIG. 15 is an enlarged view of a portion indicated by D in FIG. 14.

FIG. 16 is a sectional view which shows another example of a sectional shape of an outer circumferential face of the encoder.

FIG. 17 is a sectional view which shows Embodiment 13 of the invention.

FIGS. 18A-18C are sectional views which show Embodiment 14 of the invention.

FIG. 19 is a sectional view which shows Embodiment 15 of the invention.

FIG. 20 is a sectional view which shows a first example of a conventional construction.

FIG. 21 is a sectional view which shows a second example of a conventional construction.

FIG. 22 is a sectional view which shows a third example of a conventional construction.

FIG. 23 is a sectional view which shows a fourth example of a conventional construction.

### BEST MODE FOR CARRYING OUT THE INVENTION

A wheel supporting bearing assembly according to the invention can be embodied by using tapered rollers or balls as pluralities of rolling elements, as set forth in the second aspect of the invention.

In addition, when embodying the wheel supporting bearing assembly set forth in the third aspect of the invention, according to a fourth aspect of the invention, a stepped surface is preferably provided on the outer circumferential surface of the spacer and part of the rotor is brought into colliding abutment with this stepped surface so provided.

In the event that the configuration like this is adopted, the axial positioning of the rotor is facilitated.

Additionally, in the event that the wheel supporting bearing assembly of the invention is embodied in the construction in which the pair of inner races and the shaft member are made up of parts which are separate from each other, according to a sixth aspect of the invention, a difference in axial dimension between the pair of inner races is 2 mm or smaller.

In the event that the configuration like this adopted, not only when the axial dimensions of the pair of inner races are identical to each other but also even when the axial dimensions are not so, the pair of inner races can be produced individually with good efficiency using the same (a single) machining line without any change in arrangement of the production lines or with a minor change therein. Consequently, the production costs for the pair of inner races can be suppressed.

In addition, the production method set forth in the eighth aspect of the invention can be embodied in the following way. Namely, according to a ninth aspect of the invention, the wheel supporting bearing assembly of interest is such that the pair of inner races and the shaft member are made up of parts which are separate from each other, such that the middle step of assembling work of the individual parts which make up the wheel supporting bearing assembly is a step which results after the double-row bearing unit has been assembled which is made up by assembling together the pair of inner races, the outer race, the pluralities of rolling elements and the spacer (in such a manner that axial end faces of the spacer are brought into colliding abutment with axial end faces of both the inner races, respectively) but before the pair of inner races are fitted on the outer circumferential surface of the shaft member with interferences, and furthermore, such that the proper value for the internal clearance of the double-row bearing unit in the middle step is determined in consideration of a reduction amount in the internal clearance of the double-row bearing unit which is produced in association with fitting the pair of inner races on the outer circumferential surface of the shaft member with interferences and a reduction amount in the internal clearance of the double-row bearing unit which results in association with applying the force to the pair of inner races in the direction which causes the pair of inner races to approach each other with respect to the axial direction thereof.

Additionally, the production method set forth in the ninth aspect of the invention can be embodied in the following way. Namely, according to a tenth aspect of the invention, the reduction amount in the internal clearance of the double-row bearing unit which is produced in association with fitting the pair of inner races on the outer circumferential surface of the shaft member with interferences is obtained for each wheel supporting bearing assembly to be actually assembled. Namely, the reduction amount of the internal clearance is obtained by measuring inside diameters of the pair of inner races and an outside diameter of the shaft member are measured, respectively, for each wheel supporting bearing assembly to be actually assembled and calculating expansion amounts of the pair of inner races making use of respective resultant measured values.

According to this configuration, even though a production error occurs on each of the constituent parts of the wheel supporting bearing assembly, the reduction amount of the internal clearance can be obtained accurately. Due to this, the proper value for the internal clearance in the double-row bearing unit in the middle step can be determined more accurately. As a result, the variability of the internal clearance in the double-row bearing unit in use can be reduced further.

In addition, the production method set forth in the eighth aspect of the invention can be embodied in the following way. Namely, according to, for example, an eleventh aspect of the invention, the middle step of assembling work of the individual parts which make up the wheel supporting bearing assembly is a step which results after the inner race of the pair of inner races which is separate from the shaft member has been fitted on the outer circumferential surface of the shaft member and the double-row bearing unit has been assembled which is made up by assembling together the pair of inner races, the outer race, the pluralities of rolling elements and the spacer (in such a manner that axial end faces of the spacer are brought into colliding abutment with axial end faces of both the inner races, respectively), and furthermore, the proper value for the internal clearance of the double-row bearing unit in the middle step is determined in consideration of a reduction amount in the internal clearance of the double-row bearing unit which results in association with applying the force to the pair of inner races in the direction which causes the pair of inner races to approach each other with respect to the axial direction thereof.

In addition, the production method set forth in the eighth to eleventh aspects of the invention can be embodied in the following way. Namely, according to a twelfth aspect of the invention, a spacer which is used as a constituent part of the wheel supporting bearing assembly in place of the spacer used for the measurement is a spacer which is different from the spacer used for the measurement and which is worked to adjust an axial dimension thereof.

Additionally, according to a thirteenth aspect of the invention, a spacer which is used as a constituent part of the wheel supporting bearing assembly in place of the spacer used for the measurement is the spacer which is used for the measurement but which is worked to adjust an axial dimension thereof.

Furthermore, according to a fourteenth aspect of the invention, a spacer which is used as a constituent part of the wheel supporting bearing assembly in place of the spacer used for the measurement is a spacer which is selected from a plurality of spacers which are prepared before starting the assembly work of the wheel supporting bearing assembly and which are different from each other in axial dimension thereof.

### Embodiment 1

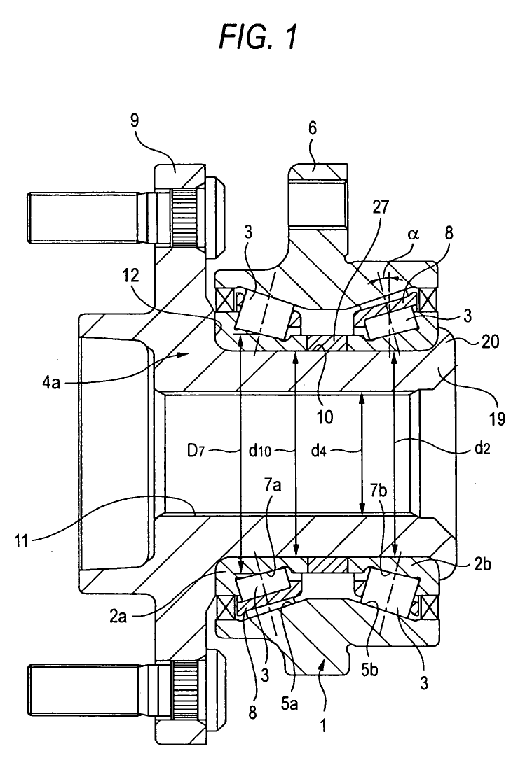

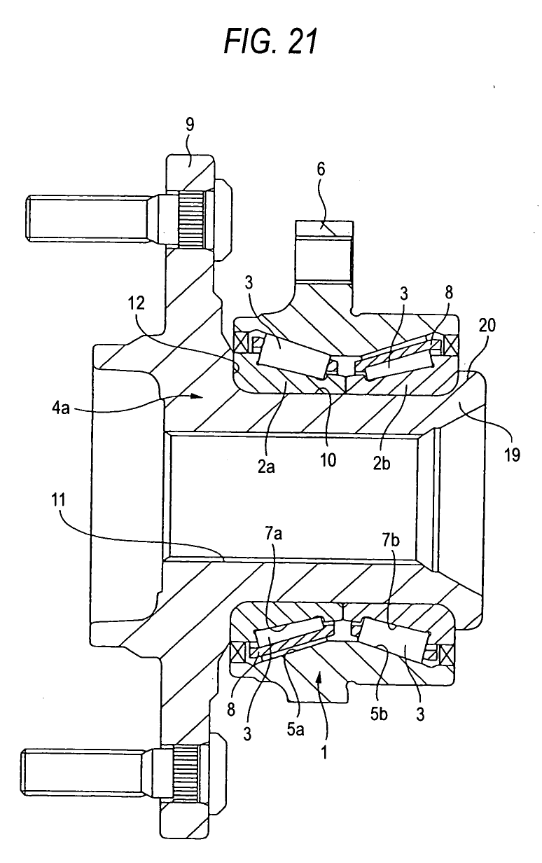

FIG. 1 shows Embodiment 1 which corresponds to the first, second, sixth, seventh, eighth, ninth, tenth and twelfth aspects of the invention. Note that the characteristics of this embodiment reside in a point that a spacer 27, which has a rectangular section and which is configured into an annular shape as a whole, is held between a small-diameter side end face of a first inner race 2a and a small-diameter side end face of a second inner race 2b which are made to face each other and in a production method for a wheel supporting bearing assembly which includes the spacer 27. The construction and function of the other portions of Embodiment 1 are substantially similar to those of the second example of the conventional construction shown in FIG. 21, and therefore, like reference numerals are given to like portions so that the repetition of a similar description should be omitted or a similar description should be simplified, and the description will be centered at what is characteristic of the embodiment and what is different from the second example of the conventional construction.

In the case of this embodiment, the spacer 27 is made of SUJ2 steel which is a kind of bearing steel. However, in enforcing the invention, as materials used to make up the spacer, in addition to SUJ2, various kinds of materials such as bearing steels except for SUJ2, carburizing steels (SCr420 and the like), carbon steels (S45C, S55C and the like), stainless steels, ceramics (silicone nitride, silicone carbide, alumina, zirconia and the like) can be used. Among these materials, as with the embodiment, steel is used, a heat treatment such as quenching/tempering, induction hardening, or carburizing and quenching is applied to the spacer 27 as required. With such heat treatments applied thereto, the surface hardness of the spacer 27 can be increased as high as HRC65, so that a damage such as fretting wear can be made difficult to be generated on the surface of the spacer 27. As a result, it is possible to effectively prevent the removal of a pre-loaded load applied to a double-row bearing unit made up by assembling together the spacer 27, the first and second inner races 2a, 2b, an outer race 1, a plurality of tapered rollers 3, 3 and cages 8, 8 as shown in the figure. In addition, when ceramics is used as the material which makes up the spacer 27, since not only wear or the like can be made difficult to be generated on the surface of the spacer 27, but also a volumetric change in the spacer 27 can be reduced which is produced in association with a change in temperature, the change in the pre-loaded load applied to the double-row bearing unit can be prevented more effectively.

In addition, in the event of the embodiment, a difference in axial dimension between the first and second inner races 2a, 2b is 2 mm or smaller. By adopting the configuration like this, the commonization of parts over both the inner races 2a, 2b can be realized (in this case, the difference in axial dimension between the two inner races is substantially zero) or at least, the inner races 2a, 2b are made to be produced individually with good efficiency using the same machining line with no or only a slight change in arrangement in the production lines, whereby the production costs for the first and second inner races 2a, 2b can be suppressed.

Next, a method for assembling the individual parts which make up the wheel supporting bearing assembly will be described which is used to produce the wheel supporting bearing assembly of the embodiment which is configured as has been described above. In the event of the embodiment, prior to carrying out the assembling work like this, firstly, a proper value for an axial internal clearance in the double-row bearing unit is determined which should result in a state before the first and second inner races 2a, 2b which make up the double-row bearing unit are fitted on a cylindrical surface portion 10 of a hub 4a with interferences. Specifically speaking, in order to set the axial internal clearance in the double-row bearing unit to a proper value in a completed state (in-use state) of the wheel supporting bearing assembly as shown in the figure, a proper value for the axial internal clearance in the double-row bearing unit in the state resulting before the first and second inner races 2a, 2b are fitted on the cylindrical surface portion 10 of the hub 4a with interferences is determined in consideration of a reduction amount in the axial internal clearance in the double-row bearing unit which is produced in association with the fitting of the first and second inner races 2a, 2b on the cylindrical surface portion 10 of the hub 4a with interferences and a reduction amount in the axial internal clearance in the double-row bearing unit which is produced in association with the application of a force to the first and second inner races 2a, 2b by the clamping portion 20 in a direction which causes the first and second inner races 2a, 2b to approach each other.

In addition, the reduction amounts in the axial internal clearance in the individual conditions can be obtained by carrying out in advance a theoretical calculation such as an FEM (finite element method) analysis based on the shape and dimensions of the wheel supporting bearing assembly of interest or an experiment. For example, the reduction amount Δδₐ in the axial internal clearance in the double-row bearing unit (a total sum of reduction amounts in axial internal clearance of bearing portions of individual rows) which is produced in association with the fitting of the first and second inner races 2a, 2b on the cylindrical surface portion 10 of the hub 4a with interferences can be obtained from the following expression (1) which is an expression used to perform the calculation of expansion amounts which is described in the tenth aspect of the invention.

[Expression 1]
Δδₐ=Δδₐₐ+Δδ_{ab}=(λᵢ/tan α)·[Δdᵢₐ+Δd_{ib}/2] (1)

where, in this expression (1), Δδₐₐ denotes the reduction amount of the axial internal clearance in the bearing portion on the first inner race 2a side, Δδ_{ab} the reduction amount of the axial internal clearance in the bearing portion on the second inner race 2b side, α the contact angle of the double-row bearing unit, Δδᵢₐ, Δδ_{ib} interferences between the first and second inner races 2a, 2b and the cylindrical surface portion 10 of the hub 4a{=(the inside diameters of the first and second inner races 2a, 2b)−(the outside diameter of the cylindrical surface portion 10)}, λᵢ the coefficient of expansion of the first and second inner races 2a, 2b which occurs in association with the fitting of the inner races 2a, 2b on the cylindrical surface portion 10, the coefficient of expansion being expressed by the following expression (2).

[Expression 2]
λᵢ={k(1−k₀²)}/{k₀²(1−k²)+(1−k₀²)} (2)

where, in the expression (2), k denotes a ratio (d₂/D₇) of the nominal inside diameter (d₂) the first and second inner races 2a, 2b to the average diameter (D₇) of first and second inner race raceways 7a, 7b, and k0 a ration (d₄/d₁₀) of the inside diameter (d₄) of the hub 4a to the nominal outside diameter (d₁₀) of the cylindrical surface portion 10 thereof.

When a calculation based on the expression (1) is executed, the inside diameters of the first and second inner races 2a, 2b and the outside diameter of the cylindrical surface portion 10, which are both values related to the interferences Δdᵢₐ, Δd_{ib}, may be substituted, respectively, by design values thereof which are designed for the wheel supporting bearing assembly, or representative values are measured by sampling for each production lot and the representative values so measured may be substituted therefor. In reality, however, the inside diameters of the first and second inner races 2a, 2b and the outside diameter of the cylindrical surface portion 10 vary within certain ranges, respectively. Due to this, the reduction amount Δδₐ can be obtained accurately by measuring the inside diameters of the first and second inner races 2a, 2b and the outside diameter of the cylindrical surface portion 10 for each wheel supporting bearing assembly to be actually assembled so that the relevant values in the expression are substituted by actually measured values rather than by the design values or representative values. Then, in the event of the embodiment, values actually measured for each wheel supporting bearing assembly to be actually assembled are used for the calculation so as to obtain the reduction amount Δδₐ accurately. Note that a relationship between the Δdᵢₐ, Δd_{ib} and the reduction amount Δδₐ is obtained not only from a relationship between the expression (1) and the expression (2) but also from an experimental formula which is obtained in advance by verifying the relationship therebetween in an experimental fashion. The reduction amount Δδₐ due to the fitting of the inner races on the hub can be obtained more accurately by obtaining the experimental formula like this.

When a proper value for the axial internal clearance in the double-row bearing unit in the state resulting before the first and second inner races 2a, 2b are fitted on the cylindrical surface portion 10 with interferences is determined in the way described above, then, the individual parts which make up the wheel supporting bearing assembly are assembled together. To this end, in the event of the embodiment, a standard spacer 27 (not shown) is prepared which has the same basic construction as that of the spacer 27 which makes up the wheel supporting bearing assembly and whose axial dimension is known. In addition, firstly, by using this standard spacer in place of the spacer 27 (by holding the standard spacer between the first and second inner races 2a, 2b), the double-row bearing unit (a unit made up by assembling together the outer race 1, the inner races 2a, 2b, the tapered rollers 3, 3 and the spacer 27 with the hub 4a excluded in FIG. 1) is then assembled. Then, the axial internal clearance in the double-row bearing unit so made in the state resulting before the first and second inner races 2a, 2b, which make up the double-row bearing unit, are fitted on the cylindrical surface portion 10 with interferences (the state in which the double-row bearing unit stands alone) is measured by a known method such as by measuring a relative axial traveling amount between the inner races side and the outer race side. In addition, an axial dimension (a target axial dimension) of the spacer 27 which can make the axial internal clearance existing then be the proper value is determined based on a difference between the measured value and the proper value determined above. Then, the axial dimension of the spacer 27 is finished to the target axial dimension by carrying out cutting work and/or grinding work on end faces of the spacer 27. Note that the aforesaid heat treatment is applied to the spacer 27 in advance as required.

Following this, the standard spacer is removed from the double-row bearing unit which is made up using this standard spacer in the way described above, and then, the double-row bearing unit is reassembled using the spacer 27 which is finished to the target axial dimension in the way described above in place of the standard spacer. The reassembling work of the double-row bearing unit like this can easily be performed by axially pulling out one of a pair of inner race units which are made up of the first and second inner races 2a, 2b, the plurality of tapered rollers 3, 3 and the cages 8, 8 from the double-row bearing unit which is made up using the standard spacer, replacing the standard spacer by the spacer 27 in this state and thereafter reinserting the inner race unit that is pulled out so as to be located inside the outer race 1.

In addition, when the double-row bearing unit is made up again using the space 27 which is finished to the target axial dimension in the way described above, then, the first and second inner races 2a, 2b, which make up the double-row bearing unit, are fitted on the cylindrical surface portion 10 with interferences, and a clamping portion 20 is formed at an inboard end portion of the hub 4a, whereby the assembling work of the wheel supporting bearing assembly is completed. In addition, while the work of fitting the double-row bearing unit on the hub 4a can be performed by press fitting the constituent parts of the double-row bearing unit at the same time, the work can also be performed by sequentially fitting the first inner race 2a-> the spacer 27-> the second inner race 2b. As this occurs, the outer race 1 is disposed on the periphery of the hub 4a before the second inner race 2b is fitted on the hub 4a.

As has been described thus far, according to the wheel supporting bearing assembly and the method for producing the same of the invention, the reduction amount in the axial internal clearance in the double-row bearing unit which is produced in association with fitting the first and second inner races 2a, 2b on the cylindrical surface portion 10 can be obtained accurately for each wheel supporting bearing assembly to be actually assembled. Due to this, a proper value for the axial internal clearance in the double-row bearing unit in the state resulting before the first and second inner races 2a, 2b are fitted on the cylindrical surface portion 10 can be obtained more accurately for each wheel supporting bearing assembly to be actually assembled. In addition, according to the embodiment, the axial internal clearance in the double-row bearing unit in the state resulting before the first and second inner races 2a, 2b are fitted on the cylindrical surface portion 10 can be made to be the proper value. Due to this, according to the embodiment, the variability of the axial internal clearance in the double-row bearing unit in use can be reduced for each wheel supporting bearing assembly to be actually assembled. Consequently, the stabilization of the bearing performances (life, anti-seizing property, rigidity and the like) can be realized sufficiently.

In addition, according to the invention, the method for adjusting the axial dimension of the spacer 27 is adopted as the approach to adjusting the axial internal clearance in the double-row bearing unit. In particular, according to the embodiment, while the axial end faces of the spacer 27 are ground in order to adjust the axial dimension of the spacer 27, this grinding work is performed on the space 27 singly. Consequently, grinding dust produced during the grinding work can be prevented from entering the interior of the double-row bearing unit.

### Embodiment 2

Next, Embodiment 2 of the invention which corresponds to the first, second, sixth, seventh, eighth, ninth, tenth and thirteenth aspects of the invention will be described by reference to FIG. 1 which shows Embodiment 1 which has been described above. According to this embodiment, when assembling together constituent parts which make up a wheel supporting bearing assembly after a proper value for an axial internal clearance in a double-row bearing unit in a state resulting before first and second inner races 2a, 2b are fitted on a cylindrical surface portion 10 of a hub 4a with interferences is determined, the double-row assembling unit is assembled by using a spacer 27 which makes up the wheel supporting bearing assembly (by causing the spacer 27 to be held between the first and second inner races 2a, 2b) in place of the standard spacer from the beginning. In addition, the axial internal clearance in the double-row bearing unit in the state resulting before the first and second inner races 2a, 2b are fitted on the cylindrical surface portion 10 with interferences is measured by a known method. In addition, a difference between this measured value and the proper value (the measured value−the proper value) is obtained. Note that when the difference becomes a negative value, another spacer 27 is used in place of the spacer 27 used for the measurement to reassemble the double-row bearing unit, so as to obtain again the difference. Note that in order to avoid the reassembly, the thickness of the spacer 27 may be set larger to some extent in advance. In addition, the heat treatment may be applied to the spacer 27 as required in advance.

Then, when the difference becomes a positive value, then, the spacer 27 is removed from the double-row bearing unit, and cutting work and/or grinding work is applied to axial end faces of the spacer 27 so removed, so as to reduce the axial dimension of the spacer 27 by an amount corresponding to the difference, whereby a resultant axial dimension of the spacer 27 is made to be a size (a target axial dimension) which can make the axial internal clearance in the double-row bearing unit be the proper value. Thus, according to the embodiment, since the spacer 27 can be finished to the target axial dimension only by grinding the axial end faces of the spacer 27 by the amount corresponding to the difference, the assembling work can be facilitated to such an extent that the axial dimension of the spacer does not have to be measured before and after the relevant grinding work. In any case, once the spacer 27 is finished to the target axial dimension in this way, the double-row bearing unit is reassembled using the space 27 so finished. Note that when the difference becomes zero, which happens rarely, the spacer 27 used for the measurement continues to be used as the constituent part of the double-row bearing unit.

In any case, once the double-row bearing unit is assembled in which the axial internal clearance is set to the proper value in the way described above, then, the first and second inner races 2a, 2b, which make up the double-row bearing unit, are fitted on the cylindrical surface portion 10 with the interferences, and a clamping portion 20 is formed at an inboard end portion of the hub 4a, whereby the assembling work of the wheel supporting bearing assembly is completed. The other constructions and functions of Embodiment 2 are similar to those of Embodiment 1 that has been described before.

### Embodiment 3

Next, Embodiment 3 of the invention which corresponds to the first, second, sixth, seventh, eighth, ninth, tenth and fourteenth aspects of the invention will be described by reference to FIG. 1 which shows Embodiment 1 which has been described above. According to this embodiment, a plurality of kinds of spacers 27 are prepared in advance which are made slightly different in axial dimension from each other at equal intervals (or at desired intervals which are set arbitrarily) before starting assembly work of individual parts which make up a wheel supporting bearing assembly. Then, as with the Embodiment 1 that has been described before, after a double-row bearing unit has been assembled using the standard spacer 27, an axial internal clearance in the double-row bearing unit in a state resulting before first and second inner races 2a, 2b, which make up the double-row bearing unit, are fitted on a cylindrical surface portion 10 with interferences is measured by a known method. In addition, based on a difference between a resultant measured value and a proper value which is determined in advance, an axial dimension (a target axial dimension) of the spacer 27 which can make the axial internal clearance be the proper value is determined. Then, a spacer 27 having an axial dimension which is closest to the target axial dimension (an axial dimension which can allow the axial internal clearance to fall within a desired range which ranges about the proper value) is selected from the plurality of kinds of spacers 27 which are prepared in advance before starting the assembly work in the way described above. Note that in the event of the embodiment, the extent of the desired range is set equal to the intervals between the plurality of kinds of spacers 27 which are prepared in advance as has been described above.

Next, the standard spacer is removed from the double-row bearing unit which has been made up using the standard spacer, and the double-row bearing unit is reassembled using the spacer 27 selected in the way described above in place of the standard spacer. Then, the first and second inner races 2a, 2b, which make up the double-row bearing unit, are fitted on the cylindrical surface portion 10 with interferences, and a clamping portion 20 is formed on an inboard end portion of a hub 4a, whereby the assembling work of the wheel supporting bearing assembly is completed.

According to the embodiment that has been described thus far, since the wheel supporting bearing assembly is assembled by selecting the spacer 27 having the axial dimension which is closest to the target axial dimension, depending on the kinds of spacers 27 to be prepared (an extent to which the axial dimension is divided into), there exists a possibility that the variability of the internal clearance in the double-row bearing unit in a completed state (an in-use state) becomes slightly large compared to a case like Embodiments 1, 2 which have been described before where the wheel supporting bearing assembly is assembled using the spacer 27 finished to the target axial dimension (or in a so-called custom-made fashion). Note that according to the embodiment. According to the embodiment, however, the selecting work may only has to be performed to obtain a spacer 27 for a final assembly, and there is no need to apply finishing work to axial end faces of the spacer 27. Consequently, since a spacer 27 for use for the final assembly can be obtained in a short period of time, even when a mass production of wheel supporting bearing assemblies is carried out, the production efficiency can be made better. In addition, the interval between axial dimensions (the extent to which the axial dimension is divided into) of the plurality of kinds of spacers 27 which are prepared in advance can be set arbitrarily in accordance with required accuracy on the reduction in variability of the internal clearance in the completed state (in-use state). Consequently, by setting the interval small, substantially the same internal clearance variability reduction effect as given by Embodiments 1, 2 can also be obtained. The other configurations and functions of Embodiment 3 are similar to those of Embodiment 1 that has been described before.

### Embodiment 4

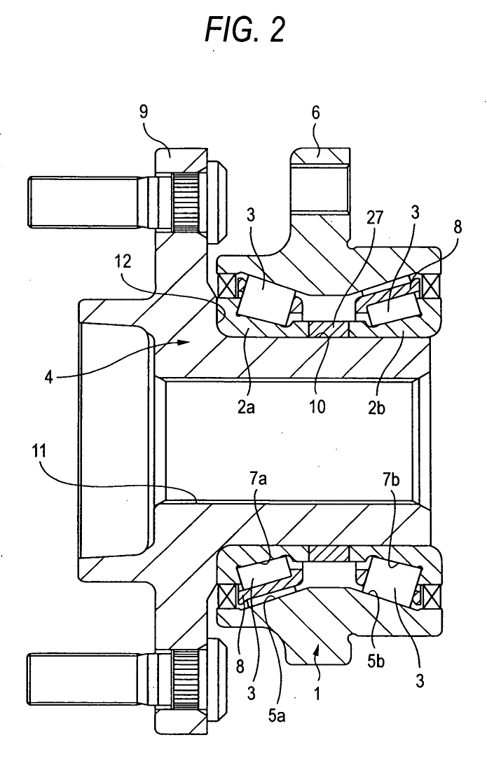

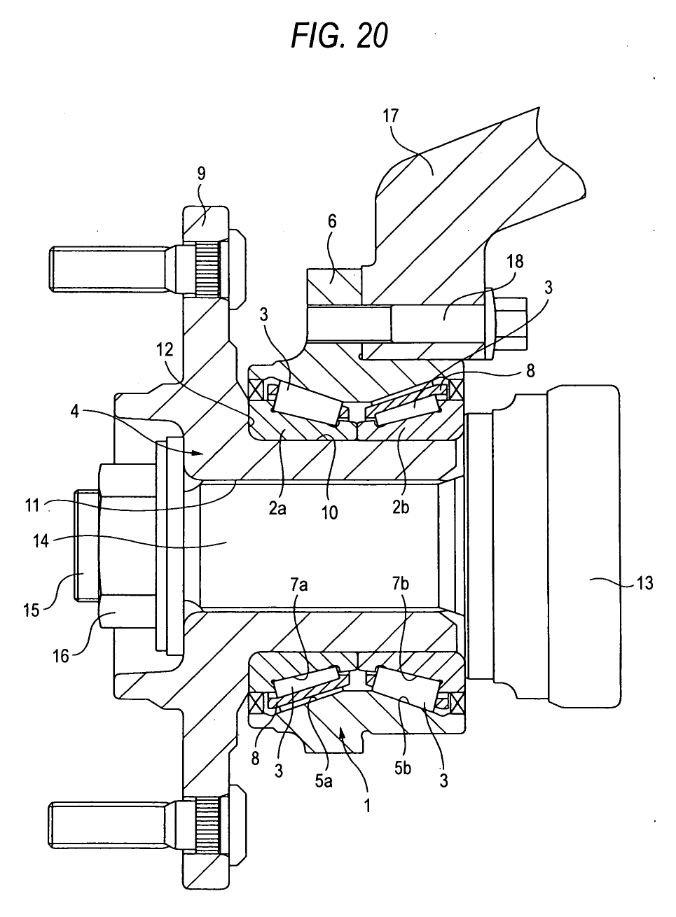

Next, FIG. 2 shows Embodiment 4 of the invention which corresponds to the first, second, sixth, seventh, eighth, ninth, tenth, twelfth, thirteenth and fourteenth aspects of the invention. According to this embodiment, as with the conventional construction shown in FIG. 20 that has been described before, the invention is applied to a construction in which an inboard end of a second inner race 2b is press secured to an outboard end face of a constant velocity joint outer race 13 (FIG. 20) in such a state that a wheel supporting bearing assembly of the embodiment is assembled to a motor vehicle (or an in-use state). The other configurations and functions of Embodiment 4 are similar to those of Embodiments 1 to 3 which have been described thus far.

### Embodiment 5

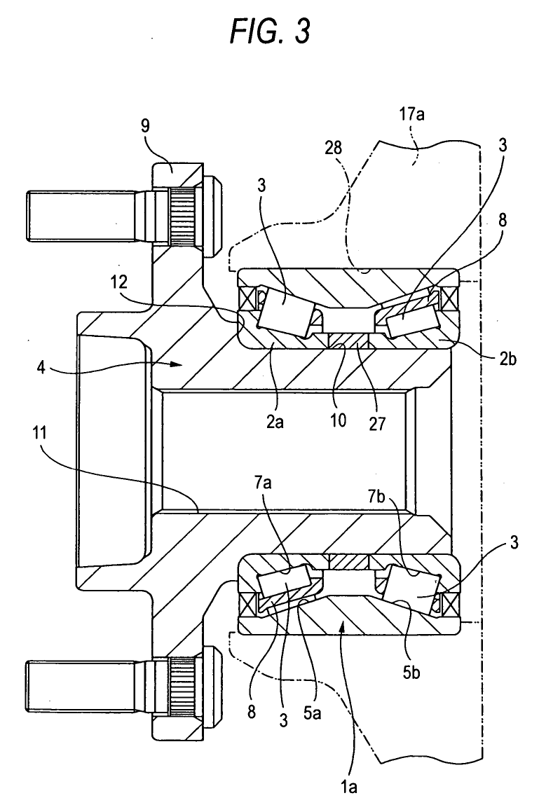

Next, FIG. 3 shows Embodiment 5 of the invention which also corresponds to the first, second, sixth, seventh, eighth, ninth, tenth, twelfth, thirteenth and fourteenth aspects of the invention. While in the event of the wheel supporting bearing assembly of Embodiment 4 shown in FIG. 2, a connecting flange 6 is provided on an outer circumferential surface of an outer race 1, in the event of this embodiment, an outer circumferential surface of an outer race 1 is made into a simple cylindrical surface. When a wheel supporting bearing assembly of the embodiment is assembled to a motor vehicle, as is shown in the figure, the outer race 1a is fitted to be supported inside a circular hole 28 provided in a knuckle 17a in such a state that the axial positioning thereof is realized. The other configurations and functions of Embodiment 5 are similar to those of Embodiment 4 shown in FIG. 2.

### Embodiment 6

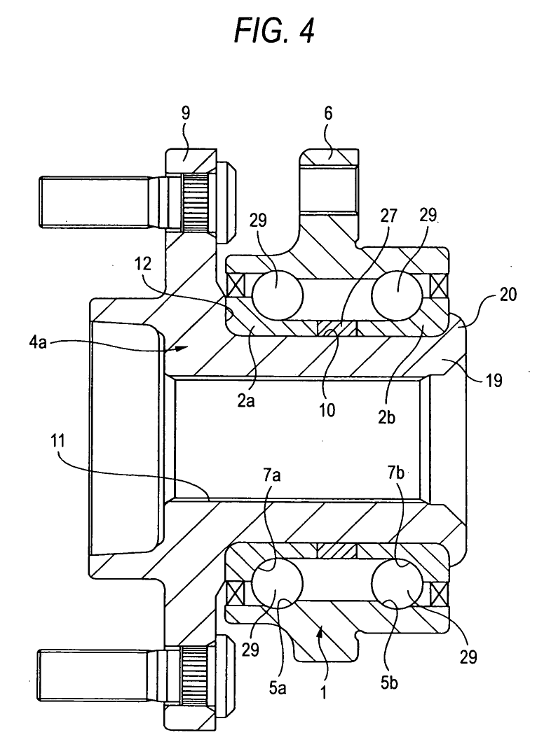

Next, FIG. 4 shows Embodiment 6 of the invention which also corresponds to the first, second, sixth, seventh, eighth, ninth, tenth, twelfth, thirteenth and fourteenth aspects of the invention. While, in Embodiments 1 to 3 shown in FIG. 1 which have been described before, the tapered rollers 3, 3 are used as the pluralities of rolling elements, according to this embodiment, balls 29, 29 are used as pluralities of rolling elements. The other configurations and functions of Embodiment 6 are similar to those of Embodiments 1 to 3 shown in FIG. 1.

### Embodiment 7

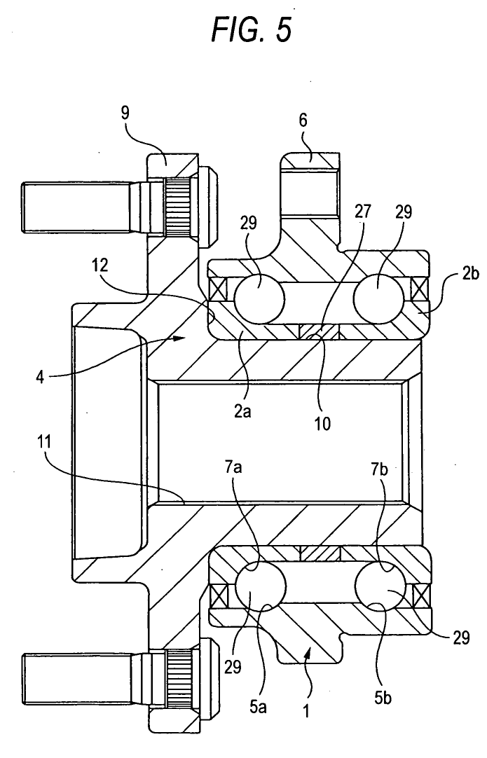

Next, FIG. 5 shows Embodiment 7 of the invention which also corresponds to the first, second, sixth, seventh, eighth, ninth, tenth, twelfth, thirteenth and fourteenth aspects of the invention. While, in the event of Embodiment 4 which is described above and shown in FIG. 2, the tapered rollers 3, 3 are used as the pluralities of rolling elements, according to this embodiment, balls 29, 29 are used as pluralities of rolling elements. The other configurations and functions of Embodiment 7 are similar to those of Embodiment 4 shown in FIG. 2.

### Embodiment 8

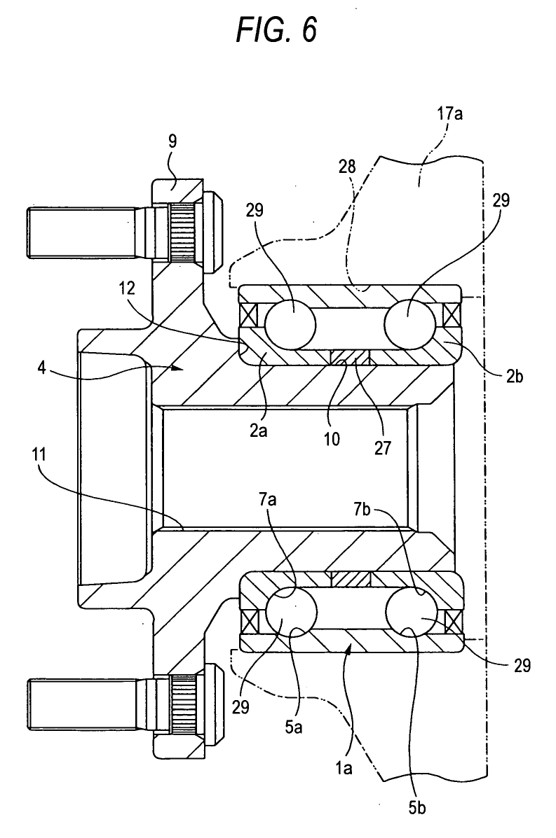

Next, FIG. 6 shows Embodiment 8 of the invention which also corresponds to the first, second, sixth, seventh, eighth, ninth, tenth, twelfth, thirteenth and fourteenth aspects of the invention. While, in the event of Embodiment 5 which is described above and shown in FIG. 3, the tapered rollers 3, 3 are used as the pluralities of rolling elements, according to this embodiment, balls 29, 29 are used as pluralities of rolling elements. The other configurations and functions of Embodiment 8 are similar to those of Embodiment 5 shown in FIG. 3.

### Embodiment 9

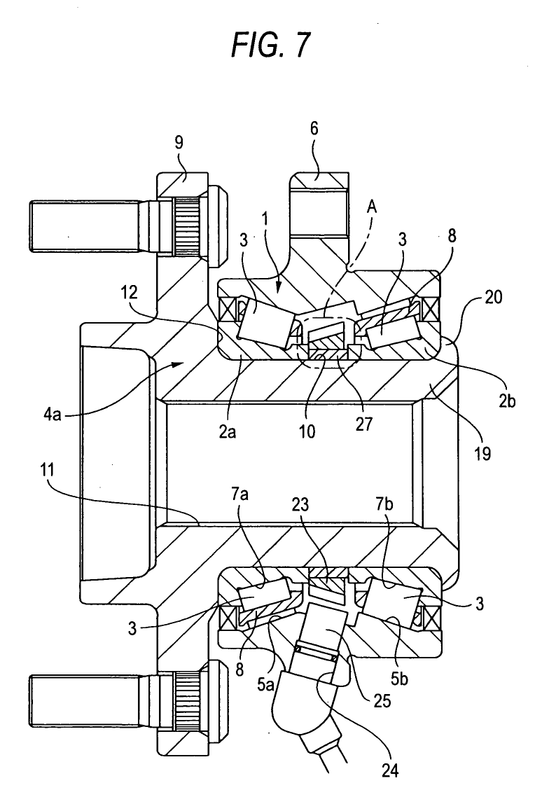

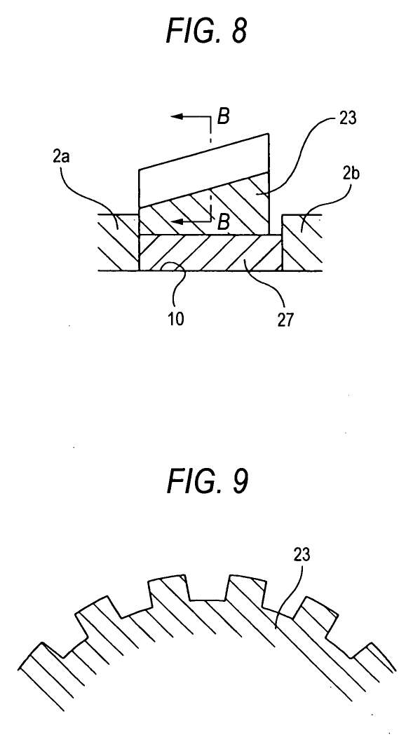

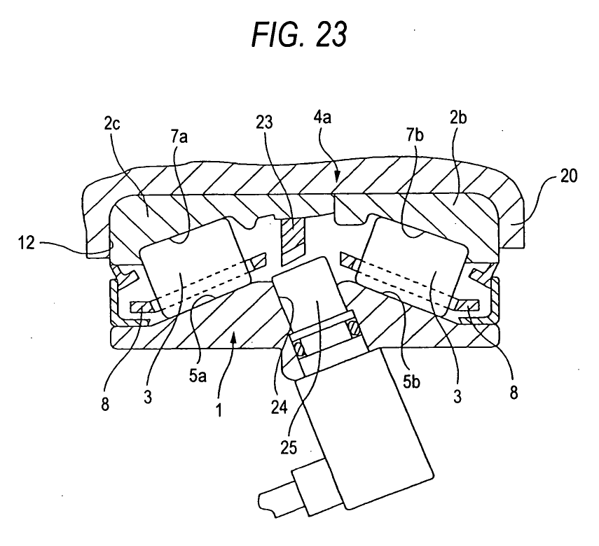

Next, FIGS. 7 to 9 show Embodiment 9 of the invention which corresponds to the first, second, third, sixth, seventh, eighth, ninth, tenth, twelfth, thirteenth and fourteenth aspects of the invention. According to this embodiment, a construction is adopted in which a wheel rotational speed detecting device (an encoder 23 and a wheel rotational speed detecting sensor 25) which is similar to that provided in the conventional construction which is described above and shown in FIG. 23 is assembled to the wheel supporting bearing assemblies of Embodiments 1 to 3 shown in FIG. 1. In the event of the embodiment, however, the encoder 23 is fitted through interference fit on an outer circumferential surface of a spacer 27 which is held between first and second inner races 2a, 2b. In addition, an axial positioning of this encoder 23 is realized by bringing a side of the encoder 23 into colliding abutment with a small-diameter side end face of the first inner race 2a in that state. Note that while, in the event of this embodiment, the encoder 23 is made by pressing or cutting a soft steel which is a magnetic material, the encoder 23 can be made of, for example, a sintered alloy (iron-based, SUS-based).

According to the embodiment which is configured as described above, since the configuration is adopted in which the encoder 23 is fitted to be supported on the spacer 27, there is no need to provide a fitting portion on which the encoder 23 is fitted to be supported at a small-diameter side end face of either of the first and second inner races 2a, 2b. Consequently, although the construction is adopted in which the wheel rotational speed detecting device is assembled between the pair of rows of rolling elements, as with Embodiment 1 which has been described before, a difference in axial dimension between the first and second inner races 2a, 2b can be made 2 mm or smaller. Due to this, also in the case of this embodiment, the commonization of parts over both the inner races 2a, 2b can be realized or at least, the inner races 2a, 2b are made to be produced individually with good efficiency using the same machining line with no or only a slight change in arrangement in the production lines, whereby the production costs for the first and second inner races 2a, 2b can be suppressed.

In addition, according to this embodiment, since the side of the encoder 23 is brought into colliding abutment with the small-diameter side end face of the first inner race 2a, the axial positioning of the encoder 23 can be realized. Note that while, in this embodiment, the configuration is adopted in which the side of the encoder 23 is brought into colliding abutment with the small-diameter side end face of the first inner race 2a in order to realize the axial positioning of the encoder 23, in place of this configuration, a configuration may be adopted in which the side of the encoder 23 is brought into colliding abutment with a small-diameter side end face of the second inner race 2b. The other configurations and functions of Embodiment 9 are similar to those of Embodiments 1 to 3 which are described above and shown in FIG. 1 and those of the conventional construction which has been described before and is shown in FIG. 23.

### Embodiment 10

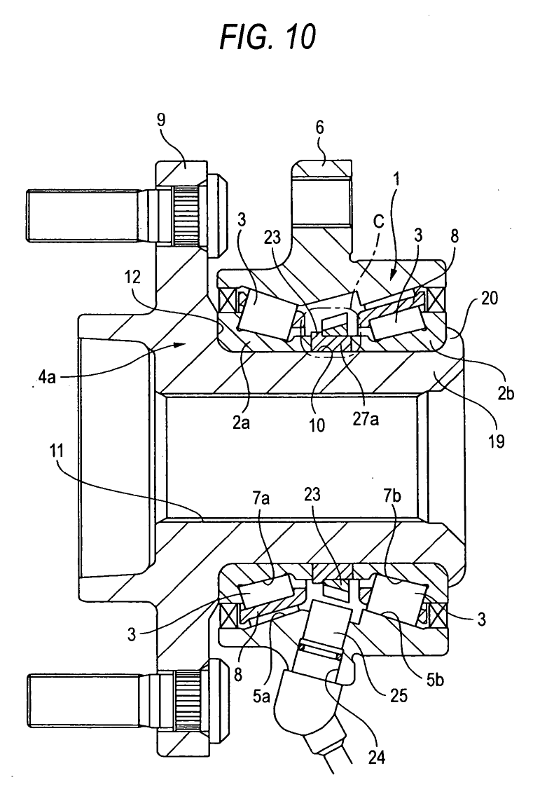

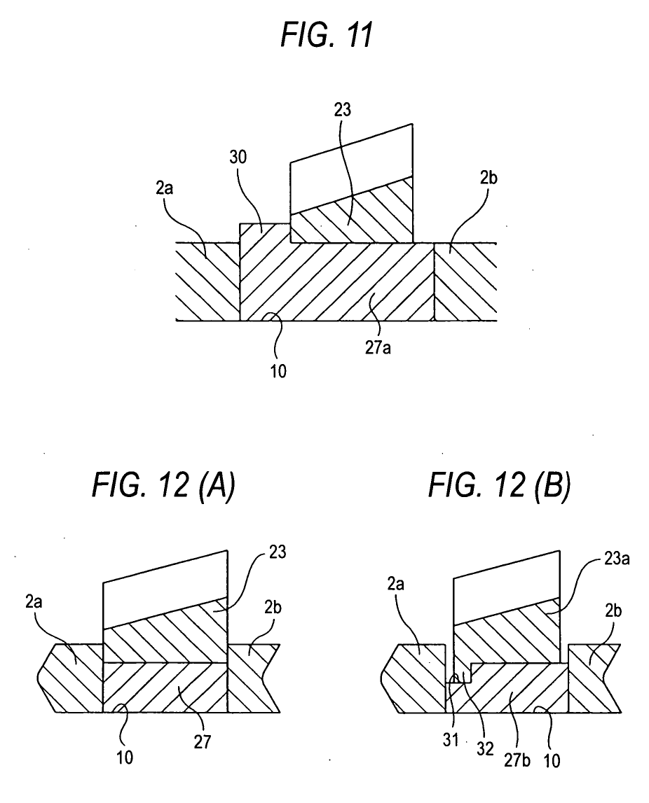

Next, FIGS. 10 to 11 show Embodiment 10 of the invention which corresponds to the first, second, third, fourth, sixth, seventh, eighth, ninth, tenth, twelfth, thirteenth and fourteenth aspects of the invention. According to this embodiment, a raised portion 30 is formed along the full circumference of an outer circumferential surface of a spacer 27a at an outboard end portion thereof in such a manner as to protrude radially outwards therefrom. In addition, an axial positioning of an encoder 23 which is fitted on the outer circumferential surface of the spacer 27a at an intermediate portion thereof through interference fit is realized by bringing a side of the encoder 23 into colliding abutment with a side (a stepped surface) of the raised portion 30. Note that while, in the embodiment, the raised portion 30 is provided at the outboard end portion on the outer circumferential surface of the spacer 27a, the raised portion 30 may be provided at an inboard end portion on the outer circumferential surface. In addition, while, in the case of the embodiment, the raised portion 30 is formed along the full circumference of the outer circumferential surface of the spacer 27a, the raised portion 30 can be provided circumferentially partially (one to a plurality of locations) on the outer circumferential surface. The other configurations and functions of Embodiment 10 are similar to those of Embodiment 9 that has been described just above.

In addition, when carrying out the invention, as the method for axially positioning the encoder fitted on the spacer, as shown in FIG. 12(A), for example, a method can be adopted in which an encoder 23 is held between first and second inner races 2a, 2b. As this occurs, even though an interference at a fitting portion between the encoder 23 and the spacer 27 is set small, the axial positioning of the encoder 23 can be realized. Consequently, even though an encoder made of a sintered alloy is used as the encoder 23, the generation of a damage such as a crack in the encoder 23 can be prevented which would otherwise happen in association with the fitting of the encoder 23 on the spacer 27. In addition, similarly, as the method for axially positioning the encoder, a method can be adopted in which as shown in FIG. 12(B), a side of a raised portion 32 formed on an inner circumferential surface of an encoder 23a is brought into colliding abutment with a side (a stepped surface) of a recessed portion 31 formed on an outer circumferential surface of a spacer 27b.

### Embodiment 11

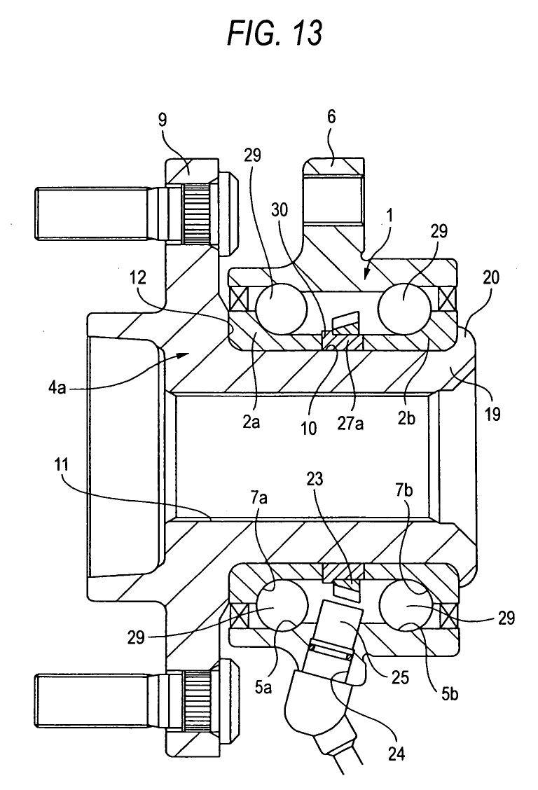

Next, FIG. 13 shows Embodiment 11 of the invention which also corresponds to the first, second, third, fourth, sixth, seventh, eighth, ninth, tenth, twelfth, thirteenth and fourteenth aspects of the invention. While in Embodiment 10 shown in FIGS. 10 to 11 which has been described just above, tapered rollers 3, 3 are used as pluralities of rolling elements, according to this embodiment, balls 29, 29 are used as the pluralities of rolling elements. The other configurations and functions of Embodiment 11 are similar to those of Embodiment 10 shown in FIG. 10 to 11.

### Embodiment 12

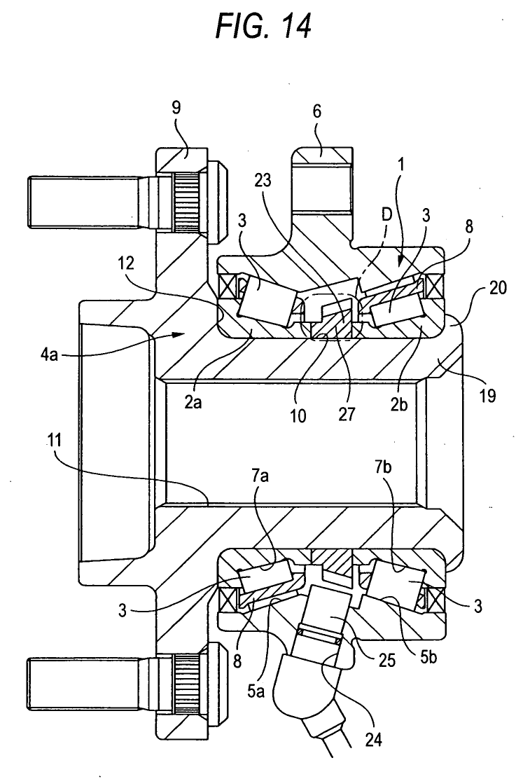

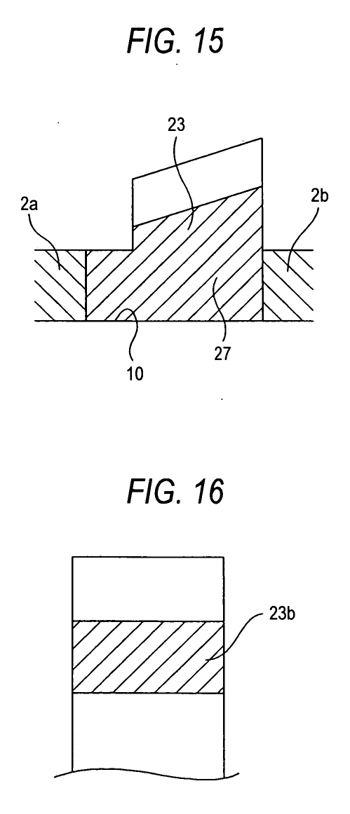

Next, FIGS. 14 to 15 show Embodiment 12 which corresponds to the first, second, fifth, sixth, seventh, eighth, ninth, tenth, twelfth, thirteenth and fourteenth aspects of the invention. According to this embodiment, an encoder 23 is provided integrally on an outer circumferential surface of a spacer 27. While an integral part made up of the spacer 27 and the encoder 23 can be made from the various kinds of materials as with each of the embodiments that have been described thus far, according to the embodiment, the integral part is made from a steel material which is a magnetic material in order to secure the function of the encoder 23. In addition, a similar heat treatment to that described in each of the embodiments that have been described before is applied to at least a spacer 27 portion as required. Additionally, teeth on an outer circumferential surface of the encoder 23 are formed by a common gear teeth forming method such as cutting, forming and the like.

As has been described above, according to a wheel supporting bearing assembly of the embodiment, since the spacer 27 and the encoder 23 are provided integrally with each other, an axial positioning of the encoder 23 as well as the spacer 27 is achieved when the wheel supporting bearing assembly is assembled. In addition, since not only the number of parts but also the number of assembling manhours can be reduced by such an extent that the spacer 27 and the encoder 23 are provided integrally with each other, the reduction in production cost can be achieved. Additionally, in the event that the spacer 27 is separated from the encoder 23, since the thickness (the radial dimension) of each of the spacer 27 and the encoder 23 needs to be increased to some extent in order to secure strengths required for the spacer 27 and the encoder 23, respectively, the height (the radial dimension) of a section resulting when both the parts are combined together cannot be made low too much. Consequently, when they are provided separately from each other, the outside diameter of the encoder 23 tends to be increased. In contrast to this, according to the embodiment, since the spacer 27 and the encoder 23 are provided integrally with each other, even when the strength of the integral part is attempted to be secured in a required amount, the height of the section of the integral part can be made low sufficiently compared to the case where the spacer 27 and the encoder 23 are provided separately. Consequently, according to the embodiment, the outside diameter of the encoder 23 can be made small compared to the case where the spacer 27 and the encoder 23 are provided separately. In addition, the degree of freedom in designing the wheel supporting bearing assembly can be increased by reducing the outside diameter of the encoder 23 in the way described above. The other configurations and functions of Embodiment 12 are similar to those of Embodiment 9 which is described above and shown in FIG. 7.

Note that while, in each of the embodiments that have been described heretofore, the sectional shape of the outer circumferential surface of the encoder 23 (23a) is formed into a straight-line shape which is inclined relative to a center axis, when carrying out the invention, for example, as shown in FIG. 16, the sectional shape of an outer circumferential surface of an encoder 23b can also be formed into a straight-line shape which is parallel with the center axis. Also when the encoder 23b like this is used, a distal end face of a wheel rotational speed detecting sensor is made to face part of the outer circumferential surface of the encoder 23b in parallel and in close proximity thereto.

### Embodiment 13

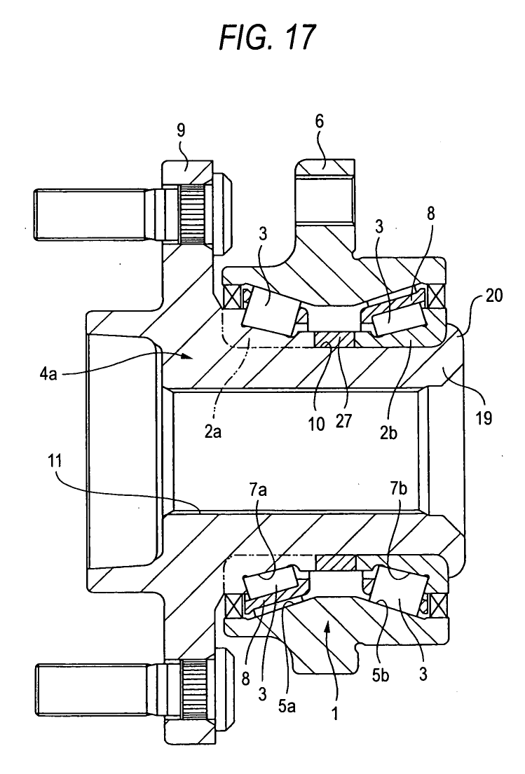

Next, FIG. 17 shows Embodiment 13 which corresponds to the first, second, sixth, seventh, eighth, eleventh, twelfth, thirteenth and fourteenth aspects of the invention. While in the wheel supporting bearing assembly which has been described above and is shown in FIG. 1, the first and second inner races 2a, 2b and the hub 4a are made up of parts which are separate from each other, according to a wheel supporting bearing assembly of the embodiment, of first and second inner races 2a, 2b, only the second inner race 2b is made up of a part which is separate from a hub 4a, whereas the first inner race 2a is formed integrally with an outer circumferential surface of the hub 4a.

According to the embodiment, when performing assembling work of the wheel supporting bearing assembly which is configured as has just been described above, a proper value is determined for an axial internal clearance in a double-row bearing unit which is produced in a state resulting after the double-row bearing unit is made up by assembling together the first inner race 2a which is formed integrally with the hub 4a as has been described above, the second inner race 2b, a spacer 27, an outer race 1, pluralities of tapered rollers 3, 3, and cages 8, 8, and before a clamping portion 20 is formed at an inboard end portion of the hub 4a (a force is applied to the first and second inner races 2a, 2b in a direction which causes the first and second inner races 2a, 2b to approach each other with respect to an axial direction thereof). To be specific, a proper value for the axial internal clearance in the double-row bearing assembly in the state resulting before the clamping portion 20 is formed is determined in consideration of a reduction amount of the axial internal clearance in the double-row bearing unit which is produced in association with the formation of the clamping portion 20 in order to make the axial internal clearance in the double-row bearing assembly in a completed state (an in-use state) of the wheel supporting bearing assembly shown in the figure be the proper value. Note that as has been described before, the reduction amount of the axial internal clearance which is produced in association with the formation of the clamping portion 20 can be obtained by carrying out a theoretical calculation such as an FEM (finite element method) analysis based on the shape and dimensions of the wheel supporting bearing assembly of interest or an experiment.

In addition, when carrying out assembling work of the wheel supporting bearing assembly, as with Embodiments 1 to 3 which have been described before, the axial internal clearance in the double-row bearing unit in the state resulting after the double-row bearing unit is assembled but before the clamping portion 20 is formed is measured using the standard spacer or a spacer 27 having a temporary axial dimension. Then, based on a difference between a resultant measured value and the proper value, also as with Embodiments 1 to 3 which have been described before, a spacer 27 is obtained which has an axial dimension which can make the internal clearance in the double-row bearing unit in the state resulting before the clamping portion 20 is formed be the same as the proper value or fall within a desired range which ranges about the proper value. Then, the double-row bearing unit is reassembled using the spacer 27 so obtained, and furthermore, the clamping portion 20 is formed, whereby the assembling work of the wheel supporting bearing assembly is completed. The other configurations and functions of Embodiment 13 are identical to those of Embodiments 1 to 3 which have been described before and is shown in FIG. 1.

Note that a wheel supporting bearing assembly with a wheel rotational speed detecting device in which an encoder is fitted on an outer circumferential surfaced of the spacer 27 can be carried out for the construction like this embodiment in which the first inner race 2a is formed integrally on the outer circumferential surface of the hub 4a.

### Embodiment 14

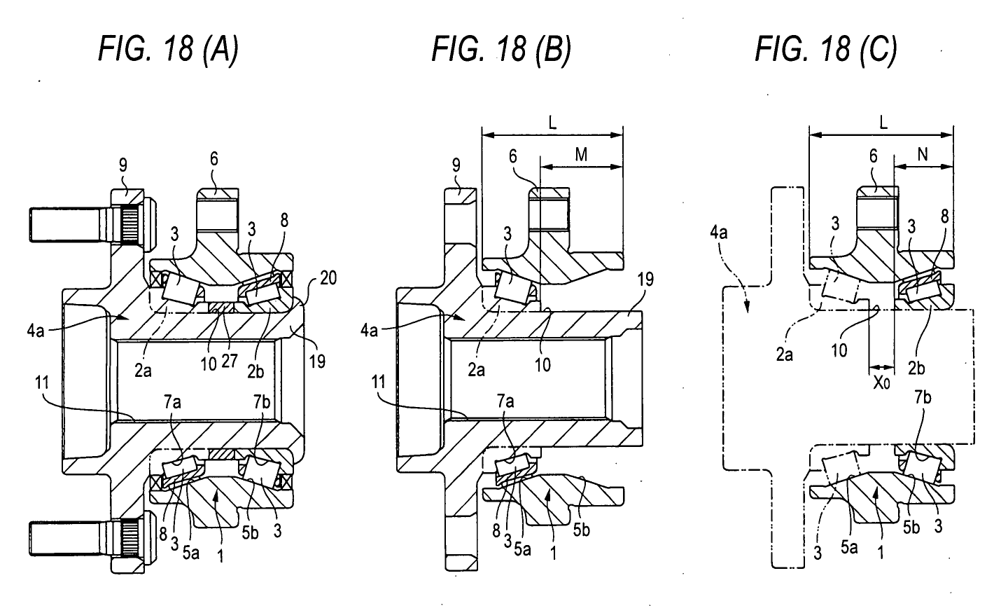

Next, FIG. 18 shows Embodiment 14 of the invention which corresponds to the first, second, sixth and seventh aspects of the invention. As shown in FIG. 18(A), a wheel supporting bearing assembly at which this embodiment is aimed is such as to be the same as the wheel supporting bearing assembly which has been described before and is shown in FIG. 17. According to the embodiment, however, an assembling method of the wheel supporting bearing assembly differs from that of Embodiment 13 which has been described before.

Namely, according to this embodiment, when assembling the wheel supporting bearing assembly, firstly, before assembling together individual constituent parts, an axial dimension L of an outer race 1 is measured. Following this, as shown in FIG. 18(B), a first inner race unit is made up by assembling together a first inner race 2a which is formed integrally with a hub 4a, a plurality of tapered rollers 3, 3, and a cage 8, and a first bearing portion is made by inserting the first inner race unit inside a first outer race raceway 5a formed on an inner circumferential surface of the outer race 1. Then, in this state, an axial dimension M between a small-diameter side end face of the first inner race 2a and an inboard end face of the outer race 1 is measured. Following this, as shown in FIG. 18(C), the first inner race unit is pulled out of the inside of the outer race 1, while a second inner race unit is made up by assembling together a second inner race 2b, a plurality of tapered rollers 3, 3, and a cage 8, and the second inner race unit so made is then inserted inside a second outer race raceway 5b formed on the inner circumferential surface of the outer race 1, whereby a second bearing portion is made up. Then, in this state (the state in which the second inner race 2b is not fitted on the hub 4a), an axial dimension N between a small-diameter side end face of the second inner race 2b and the inboard end face of the hub 4a is measured.

Here, an axial dimension X₀ {FIG. 18(C)} between the small-diameter side end face of the first inner race 2a in such a state that the outer race 1 and only the first inner race unit are combined together and the small-diameter side end face of the second inner race 2b in such a state that the outer race 1 and only the second inner race unit are combined together can be expressed in the following expression (3) from a geometric relationship using the individual dimensions L, M, N which are measured in the ways described above.
X₀=N+M−L (3)

Here, assuming that the axial internal clearance (the proper value) in the double-row bearing unit in the completed state (the in-use state) of the wheel supporting bearing assembly is Z, the reduction amount of the axial internal clearance in the second bearing portion which is produced in association with the fitting of the second inner race 2b on the hub 4a is Δδ_{ab}, and the reduction amount in the axial internal clearance in the double-row bearing unit which is produced in association with the application of axial force by forming the clamping portion 20 is Δδₐⱼ, an initial clearance {the axial internal clearance (the proper value) resulting when assuming that the second inner race 2b is not fitted on the hub 4a through interference fit and before the clamping portion 20 is formed} Z₀ in the double-row bearing unit can be expressed in the following expression (4).
Z₀=Z+Δδ_{ab}+Δδₐⱼ (4)

Note that Δδ_{ab} in this expression (4) can be obtained by a similar method to that of Embodiment 1 that has been described before using the diameters of the inner circumferential surface of the second inner race 2b and the outer circumferential surface of the hub 4a which fitted on and in each other. In addition, the aforesaid Δδₐⱼ can also be obtained through FEM analysis and experiment as has been described before.

Consequently, from the expressions (3) and (4), the axial dimension X of the spacer 27 which is necessary to obtain the initial axial internal clearance (the proper value) in the double-row bearing unit can be expressed in the following expression (5).
X=X₀+Z₀ (5)

It is seen from this expression (5) that in the event that the initial clearance Z₀ becomes negative (a negative clearance), the axial dimension X of the spacer 27 becomes smaller than the axial dimension X₀, whereas in the event that the initial clearance Z₀ becomes positive (a positive clearance), the axial dimension X of the spacer 27 becomes larger than the axial dimension X₀. Thus, according to the embodiment, after the axial dimension X of the spacer 27 is obtained from the expression (5), a spacer 27 having the axial dimension X (or an axial dimension which is extremely close thereto) is obtained by any of the methods according to Embodiments 1 to 3 which have been described before (the method for adjusting the axial dimension of a spacer that is prepared in advance by grinding the end faces of the spacer so prepared, or the method for selecting one spacer from the plurality of spacers that are prepared in advance and which are different in axial dimension from each other). Then, the variability of the axial internal clearance in the double-row bearing unit in the completed state (the in-use state) is suppressed by using the spacer 27 so obtained for final assembly of the wheel supporting bearing assembly. Note that although it is natural, letting the axial dimension of the spacer 27 used for the final assembly be X₀ which is calculated by the expression (3), the initial clearance Z₀ becomes 0.

### Embodiment 15

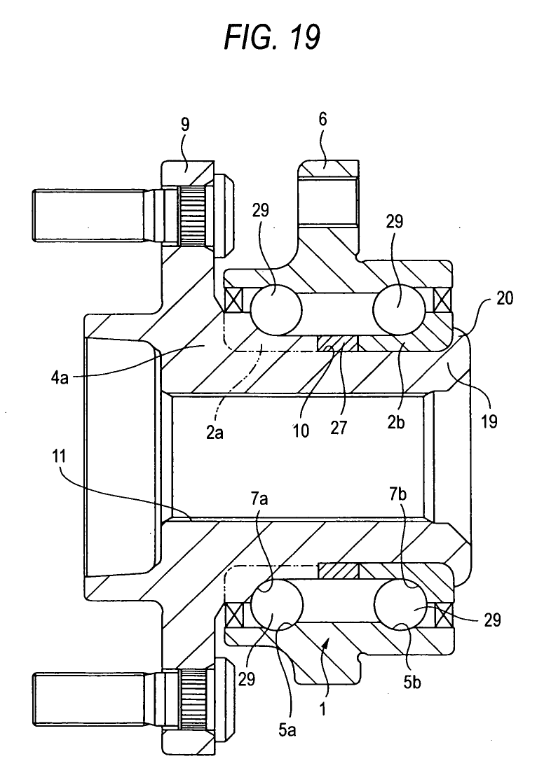

Next, FIG. 19 shows Embodiment 15 of the invention which corresponds to the first, second, sixth, seventh, eighth, eleventh, twelfth, thirteenth and fourteenth aspects of the invention. While in Embodiments 13, 14 which have been described before and are shown in FIGS. 17, 18, respectively, the tapered rollers 3, 3 are used as the pluralities of rolling elements, respectively, according to this embodiment, balls 29, 29 are used as pluralities of rolling elements. The other configurations and functions are similar to those of Embodiments 13, 14 which have been described before and are shown in FIGS. 17, 18, respectively.

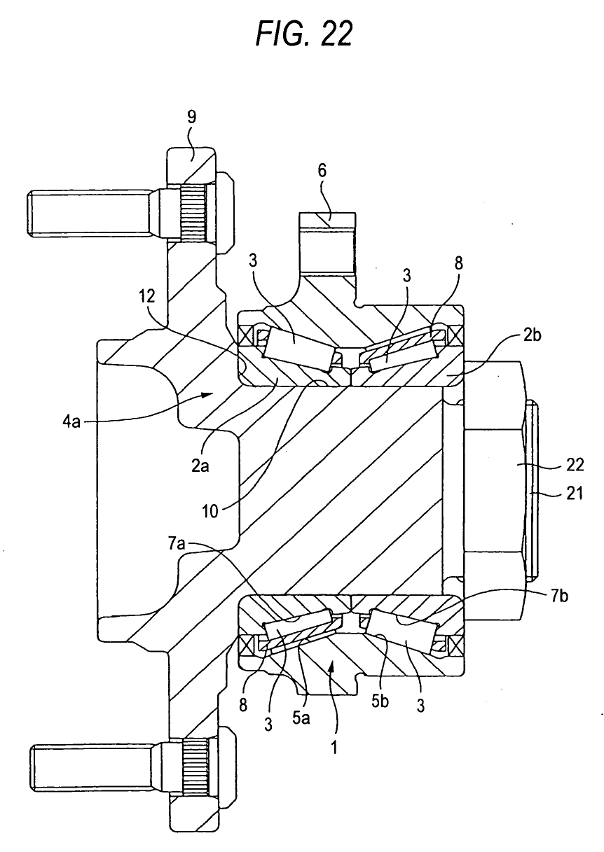

Note that while, in each of the embodiments that have been described heretofore, the invention is described as being applied to the wheel supporting bearing assembly for a drive wheel, the invention can also be applied to the wheel supporting bearing assembly for a driven wheel which has been described before and is shown in FIG. 22. In addition to this, the invention can be applied to wheel supporting bearing assemblies of various constructions which have been known conventionally.

What is claimed is:

1. A wheel supporting bearing assembly comprising:
an outer race;
a pair of inner races;
pluralities of rolling elements; and
a shaft member;
the outer race having a plurality of rows of outer race raceways formed on an inner circumferential surface thereof,
one of the pair of inner races having a single row of inner race raceway formed on an outer circumferential surface thereof and being fitted on an outer circumferential surface of the shaft member with an interference at a portion thereof or formed integrally with the shaft member at the portion thereof,
the other inner race having a single row of inner race raceway formed on an outer circumferential surface thereof and being fitted on the outer circumferential surface of the shaft member with an interference at another portion on the remaining part thereof which lies side by side to the portion where the one of the pair of inner races is disposed,
the rolling elements being provided in such a manner that the plurality of rolling elements are interposed rollingly between each of the outer race raceways and each of the inner race raceways, and adapted to be used in such a state that a force is applied to the pair of inner races in a direction which causes the inner races to approach each other with respect to an axial direction thereof, wherein
an annular spacer is held between respective axial end faces of the pair of inner races which face each other.

2. The wheel supporting bearing assembly as set forth in claim 1, wherein
the pluralities of rolling elements are tapered rollers or balls.

3. The wheel supporting bearing assembly as set forth in claim 1, wherein
a rotor making up a wheel rotational speed detecting device is fitted to be supported on an outer circumferential surface of the spacer.

4. The wheel supporting bearing assembly as set forth in claim 3, wherein
a stepped surface is provided on the outer circumferential surface of the spacer, so that part of the rotor is axially brought into colliding abutment with the stepped surface so provided.

5. The wheel supporting bearing assembly as set forth in claim 1, wherein
a rotor making up a wheel rotational speed detecting device is integrally provided on an outer circumferential surface of the spacer.

6. The wheel supporting bearing assembly as set forth in claim 1, wherein
the pair of inner races and the shaft member are made up of parts which are separate from each other, and wherein a difference in axial dimension of the pair of inner races is 2 mm or smaller.

7. A wheel supporting bearing assembly production method for producing a wheel supporting bearing assembly comprising:
an outer race;
a pair of inner races;
pluralities of rolling elements; and
a shaft member;
the outer race having a plurality of rows of outer race raceways formed on an inner circumferential surface thereof,
one of the pair of inner races having a single row of inner race raceway formed on an outer circumferential surface thereof and being fitted on an outer circumferential surface of the shaft member with an interference at a portion thereof or formed integrally with the shaft member at the portion thereof,
the other inner race having a single row of inner race raceway formed on an outer circumferential surface thereof and being fitted on the outer circumferential surface of the shaft member with an interference at another portion on the remaining part thereof which lies side by side to the portion where the one of the pair of inner races is disposed,
the rolling elements being provided in such a manner that the plurality of rolling elements are interposed rollingly between each of the outer race raceways and each of the inner race raceways, and adapted to be used in such a state that a force is applied to the pair of inner races in a direction which causes the inner races to approach each other with respect to an axial direction thereof, wherein
an annular spacer is held between respective axial end faces of the pair of inner races which face each other, the wheel supporting bearing assembly production method comprising:
determining on an axial dimension of the spacer in a middle step of assembling work of the individual parts which make up the wheel supporting bearing assembly, and using a spacer having the axial dimension so determined for assembly of the wheel supporting bearing assembly.

8. The wheel supporting bearing assembly production method as set forth in claim 7, wherein
an internal clearance of a double-row bearing unit made up by assembling together a pair of inner races, an outer race, pluralities of rolling elements and a spacer is measured in the middle step of the assembling work of the individual parts which make up the wheel supporting bearing assembly, and in the event that a resultant measured value does not coincide with a proper value which is determined in advance for the internal clearance of the double-row bearing unit in the middle step, in place of the spacer which is used for the measurement, a spacer having an axial dimension which can align the internal clearance with the proper value or make the internal clearance fall within a desired range which is centered the proper value is used as a constituent part of the wheel supporting bearing assembly in assembly of the individual parts.

9. The wheel supporting bearing assembly production method as set forth in claim 8, wherein
the wheel supporting bearing assembly of interest is such that the pair of inner races and the shaft member are made up of parts which are separate from each other, such that the middle step of assembling work of the individual parts which make up the wheel supporting bearing assembly is a step which results after the double-row bearing unit has been assembled which is made up by assembling together the pair of inner races, the outer race, the pluralities of rolling elements and the spacer but before the pair of inner races are fitted on the outer circumferential surface of the shaft member with interferences, and furthermore, such that the proper value for the internal clearance of the double-row bearing unit in the middle step is determined in consideration of a reduction amount in the internal clearance of the double-row bearing unit which is produced in association with fitting the pair of inner races on the outer circumferential surface of the shaft member with interferences and a reduction amount in the internal clearance of the double-row bearing unit which results in association with applying the force to the pair of inner races in the direction which causes the pair of inner races to approach each other with respect to the axial direction thereof.

10. The wheel supporting bearing assembly production method as set forth in claim 9, wherein
the reduction amount in the internal clearance of the double-row bearing unit which is produced in association with fitting the pair of inner races on the outer circumferential surface of the shaft member with interferences is obtained by measuring diameters of inner circumferential surfaces of the pair of inner races and the outer circumferential surface of the shaft member, respectively, for each wheel supporting bearing assembly to be actually assembled and calculating expansion amounts of the pair of inner races making use of respective resultant measured values.

11. The wheel supporting bearing assembly production method as set forth in claim 8, wherein
the middle step of assembling work of the individual parts which make up the wheel supporting bearing assembly is a step which results after the inner race of the pair of inner races which is separate from the shaft member has been fitted on the outer circumferential surface of the shaft member and the double-row bearing unit has been assembled which is made up by assembling together the pair of inner races, the outer race, the pluralities of rolling elements and the spacer, and furthermore, wherein the proper value for the internal clearance of the double-row bearing unit in the middle step is determined in consideration of a reduction amount in the internal clearance of the double-row bearing unit which results in association with applying the force to the pair of inner races in the direction which causes the pair of inner races to approach each other with respect to the axial direction thereof.

12. The wheel supporting bearing assembly production method as set forth in claim 8, wherein
a spacer which is used as a constituent part of the wheel supporting bearing assembly in place of the spacer used for the measurement is a spacer which is different from the spacer used for the measurement and which is worked to adjust an axial dimension thereof.

13. The wheel supporting bearing assembly production method as set forth in claim 8, wherein
a spacer which is used as a constituent part of the wheel supporting bearing assembly in place of the spacer used for the measurement is the spacer which is used for the measurement but which is worked to adjust an axial dimension thereof.

14. The wheel supporting bearing assembly production method as set forth in claim 8, wherein
a spacer which is used as a constituent part of the wheel supporting bearing assembly in place of the spacer used for the measurement is a spacer which is selected from a plurality of spacers which are prepared before starting the assembly work of the wheel supporting bearing assembly and which are different from each other in axial dimension thereof.
